(19) United States
(12) Patent Application Publication
(10) Pub. No.: US 2025/0371069 A1
(43) Pub. Date: Dec. 4, 2025

(54) DOCUMENT-BASED PRESENTATION GENERATION

(71) Applicant: ADOBE INC., SAN JOSE, CA (US)

(72) Inventors: Ishani Mondal, College Park, MD (US); Shwetha Somasundaram, Bangalore (IN); Anandha velu Natarajan, Bangalore (IN); Aparna Garimella, Bangalore (IN); Sambaran Bandyopadhyay, Bangalore (IN)

(21) Appl. No.: 18/675,451

(22) Filed: May 28, 2024

(51) Int. Cl. G06F 16/438; G06F 16/33; G06F 16/35; G06V 30/416

(52) U.S. Cl. CPC G06F 16/438; G06F 16/3344; G06F 16/345; G06F 16/35; G06F 16/4393; G06V 30/416

(57) ABSTRACT

A method, apparatus, non-transitory computer readable medium, and system for natural language processing include obtaining a source document and a user characteristic that indicates a complexity preference of a user. A topic description is generated, using a language generation model, based on the source document and the user characteristic. The language generation model is trained based on an objective function that measures a complexity of the topic description.

### BACKGROUND

The following relates generally to natural language processing (NLP), and more specifically to document summarization using machine learning. NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. In some examples, generative pre-trained transformer (GPT) models are trained to understand natural language and code. GPT models provide text outputs in response to their inputs (e.g., a prompt from a user).

Document summarization refers to techniques and processes of generating summary documents based on source documents. The summary documents capture the main idea and key points addressed in the source documents. In some examples, presentations using slides are an effective way to communicate in business operations, academic conferences, etc. In some cases, slide decks for presentation are more concise, appealing, and interactive compared to long source documents.

### SUMMARY

The present disclosure describes systems and methods for natural language processing. Embodiments of the present disclosure include a document processing apparatus configured to generate an output document (e.g., slide decks) based on a source document by generating one or more topic descriptions. A language generation model is trained using reinforcement learning with a reward function to generate a topic description based on the source document and a user characteristic (e.g., user expertise level, topic length preference). In some examples, the reward function is based on a percentage of technical words in the topic description or a percentage of technical topic descriptions. The language generation model retrieves content corresponding to each of the one or more topic descriptions. The output document, e.g., a multi-modal presentation document, includes a set of output sections corresponding to the one or more topic descriptions, respectively.

A method, apparatus, and non-transitory computer readable medium for natural language processing are described. One or more embodiments of the method, apparatus, and non-transitory computer readable medium include obtaining a source document; obtaining a user characteristic that indicates a complexity preference of a user; and generating, using a language generation model, a topic description based on the source document and the user characteristic, wherein the language generation model is trained based on an objective function that measures a complexity of the topic description.

A method, apparatus, and non-transitory computer readable medium for natural language processing are described. One or more embodiments of the method, apparatus, and non-transitory computer readable medium include obtaining a source document; generating, using a language generation model, a topic description based on the source document; computing an objective function that measures a complexity of the topic description; and updating the language generation model based on the objective function.

An apparatus and method for natural language processing are described. One or more embodiments of the apparatus and method include at least one processor; at least one memory including instructions executable by the at least one processor; a language generation model comprising parameters stored in the at least one memory and trained to generate a topic description based on a source document and a user characteristic; and a clustering model comprising parameters stored in the at least one memory and trained to cluster a plurality of sentences of the source document to obtain a plurality of clustered sentences corresponding to the topic description.

### BRIEF DESCRIPTION OF THE DRAWINGS

FIG. 1 shows an example of a document processing system according to aspects of the present disclosure.

FIG. 2 shows an example of a method document processing according to aspects of the present disclosure.

FIGS. 3 and 4 show examples of document-to-slides generation according to aspects of the present disclosure.

FIG. 5 shows an example of a method for natural language processing according to aspects of the present disclosure.

FIG. 6 shows an example of a document processing apparatus according to aspects of the present disclosure.

FIGS. 7 and 8 show examples of a machine learning model for text processing according to aspects of the present disclosure.

FIG. 9 shows an example of a transformer network according to aspects of the present disclosure.

FIG. 10 shows an example of a user interface according to aspects of the present disclosure.

FIG. 11 shows an example of topic descriptions according to aspects of the present disclosure.

FIG. 12 shows an example of user interface according to aspects of the present disclosure.

FIGS. 13 and 14 show examples of a user interface according to aspects of the present disclosure.

FIG. 15 shows an example of user feedback for training a clustering model according to aspects of the present disclosure.

FIG. 16 shows an example of a method for training a language generation model according to aspects of the present disclosure.

FIGS. 17 and 18 show examples of methods for training a clustering model according to aspects of the present disclosure.

FIG. 19 shows an example of a computing device for natural language processing according to aspects of the present disclosure.

### DETAILED DESCRIPTION

The present disclosure describes systems and methods for natural language processing. Embodiments of the present disclosure include a document processing apparatus configured to generate an output document (e.g., slide decks) based on a source document by generating one or more topic descriptions. A language generation model is trained using reinforcement learning with a reward function to generate a topic description based on the source document and a user characteristic (e.g., user expertise level, topic length preference). In some examples, the reward function is based on a percentage of technical words in the topic description or a percentage of technical topic descriptions. The language generation model retrieves content corresponding to each of the one or more topic descriptions. The output document, e.g., a multi-modal presentation document, includes a set of output sections corresponding to the one or more topic descriptions, respectively.

Document summarization is the process of analyzing a source document to produce a concise and appealing document that maintains key points and ideas expressed in the source document. Machine learning models have been used in document processing tasks, such as generating summaries based on input text. However, these conventional models generate a uniform output document and fail to consider the expertise level of target audience and length of output when generating presentation documents. For example, presentation documents should vary depending on the target audience (with prior knowledge on a subject versus no prior knowledge on the subject). Hence, conventional models lack control over the content creation process and the user experience is decreased.

Embodiments of the present disclosure include a document processing apparatus configured to generate a topic description based on a source document and a user characteristic. The document processing apparatus generates an output document based on the topic description. The user characteristic indicates a complexity preference of a user. For example, the complexity preference includes a topic length preference or an expertise level of the user.

In an embodiment, a language generation model generates a set of topic descriptions based on a specified target audience (e.g., user expertise level) and output length (e.g., a number of presentation slides). The language generation model is trained using reinforcement learning. At training, a reinforcement learning process is performed based on an objective function (e.g., a reward function). When generating a presentation document for a subject expert, the percentage of technical keywords and the percentage distribution of technical sections (e.g., topics related to “Experiments”, “Model Architecture”, “Results and Analysis” sections) need to be higher compared to a presentation document generated and shown to a person having less expertise on the subject. In some examples, the reward function involves generating a reward for a generated topic description by measuring a complexity of the topic description. The reward function is based on the percentage of technical words in the topic description or on the percentage of technical topic descriptions. Additionally, the reward function is based on a number of the set of topic descriptions (i.e., length).

In an embodiment, the document processing apparatus includes a multi-modal content retrieval network that takes a set of topic descriptions as input. The content retrieval network takes into account the expertise level of a user and the target output length. The content retrieval network selects section content (e.g., text, images, tables) corresponding to each of the topic descriptions based on the source document.

In an embodiment, a clustering model is trained to cluster a set of sentences of the source document to obtain a set of clustered sentences corresponding to the topic description. The clustering model is configured to align the extracted and retrieved content from the source document to customize for user needs using an explanation-driven (goal-driven) clustering method. The clustering model is configured to provide rationale behind why the content is placed in a single cluster. Next, using human feedback where the users can rearrange sentences, tables, and figures from a first slide to a second or delete content, the clustering model is trained with instruction tuning to customize based on user-specified goals. The clustering model learns to provide an explanation of why a user has done an action. The model-generated explanation is shown to the user for verification.

For example, when content is dragged from “Results” section and dropped into “Motivation” section by the user, the clustering model generates a plausible explanation behind the action, and the user is asked to verify the explanation. Once the user verifies, the new clusters are saved with new explanations and user actions with the correct rationale. The clusters and the edited history of user actions are collected through a user interface, and hence this becomes the new augmented instruction-tuning data for the clustering model.

In some examples, the clustering model is trained to perform content generation that follows user instructions and aligns with user preferences. The instruction tuning paradigm relates to fine-tuning a base language model in a supervised manner on instruction-response pairs {i, r} (where i is an instruction and r is its response) using maximum likelihood estimation (MLE). In some cases, the base language model is pre-trained on a massive text corpus using MLE.

The present disclosure describes systems and methods that improve on conventional document processing models by providing more accuracy and control over generated topics and section content for each of the generated topics. For example, users with sufficient domain knowledge (e.g., engineers working in the same field) receive topic descriptions that are suitable to their expertise level. Users having less domain knowledge receive topic descriptions that are informative and relatively easy to understand. Some embodiments achieve improved accuracy by performing a reinforcement learning process based on an objective function that rewards generated topics based on their technical content.

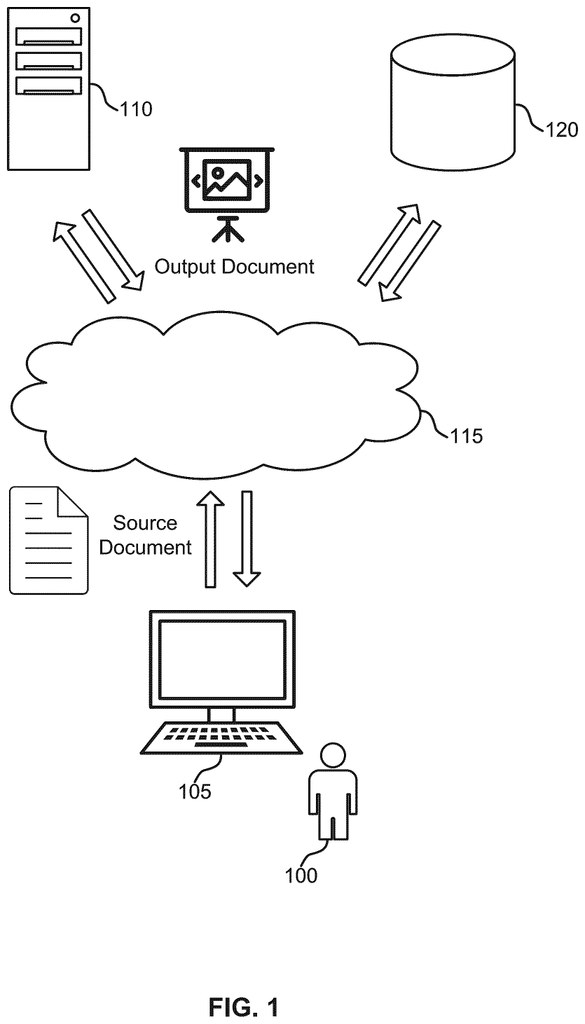

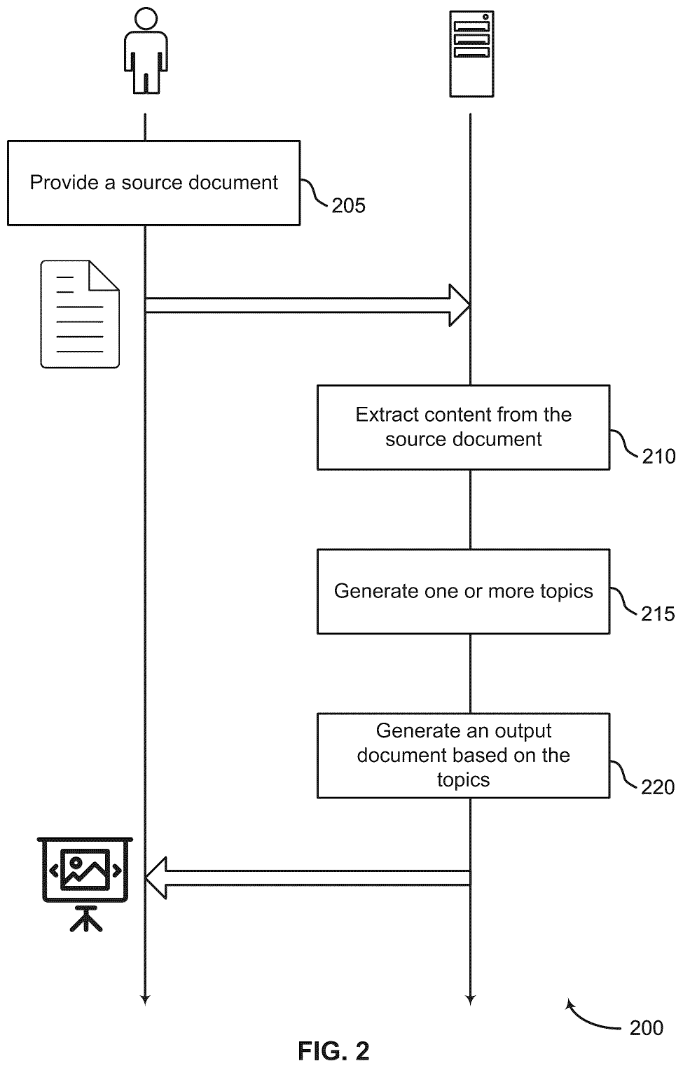

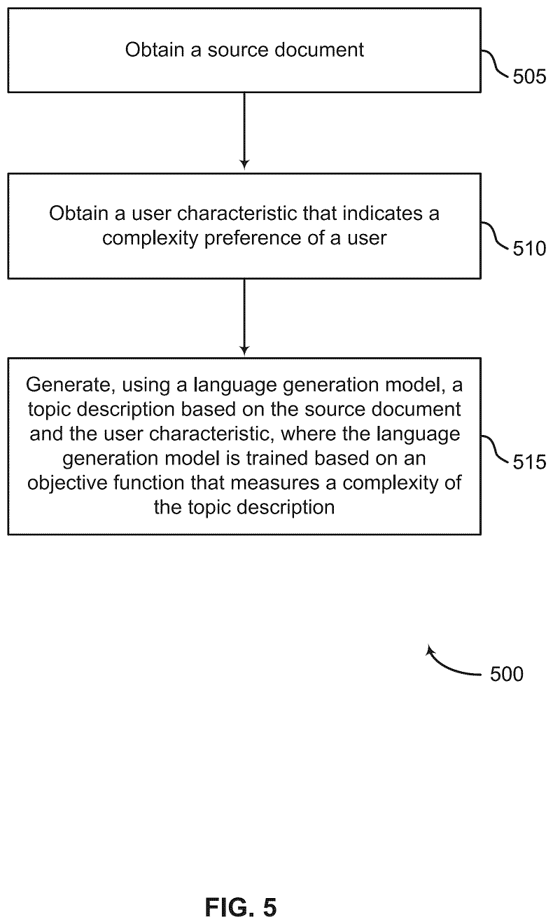

In some examples, a document processing apparatus based on the present disclosure obtains a source document, and then generates a set of topics and an output document including the topics. Examples of application in document-to-slides generation context are provided with reference to FIGS. 2-4. Details regarding the architecture of an example document processing system are provided with reference to FIGS. 1 and 6-9. Details regarding methods of natural language processing are provided with reference to FIGS. 5 and 10-14.

### Text Processing System

In FIGS. 1-5, a method, apparatus, and non-transitory computer readable medium for natural language processing are described. One or more embodiments of the method, apparatus, and non-transitory computer readable medium include obtaining a source document; obtaining a user characteristic that indicates a complexity preference of a user; and generating, using a language generation model, a topic description based on the source document and the user characteristic, wherein the language generation model is trained based on an objective function that measures a complexity of the topic description.

In some examples, the complexity preference comprises a topic length preference or an expertise level of the user. Some examples of the method, apparatus, and non-transitory computer readable medium further include generating a prompt for the language generation model based on the user characteristic, wherein the topic description is generated based on the prompt.

Some examples of the method, apparatus, and non-transitory computer readable medium further include generating an output document based on the topic description. Some examples of the method, apparatus, and non-transitory computer readable medium further include generating a prompt that includes instructions to generate the output document.

Some examples of the method, apparatus, and non-transitory computer readable medium further include generating a plurality of topics. Some examples further include clustering a plurality of sentences from the source document based on the plurality of topics, wherein the output document is based on the clustering.

Some examples of the method, apparatus, and non-transitory computer readable medium further include obtaining a multi-media asset based on the topic description, wherein the output document includes the multi-media asset.

Some examples of the method, apparatus, and non-transitory computer readable medium further include displaying the topic description to the user. Some examples further include receiving feedback from the user based on the topic description.

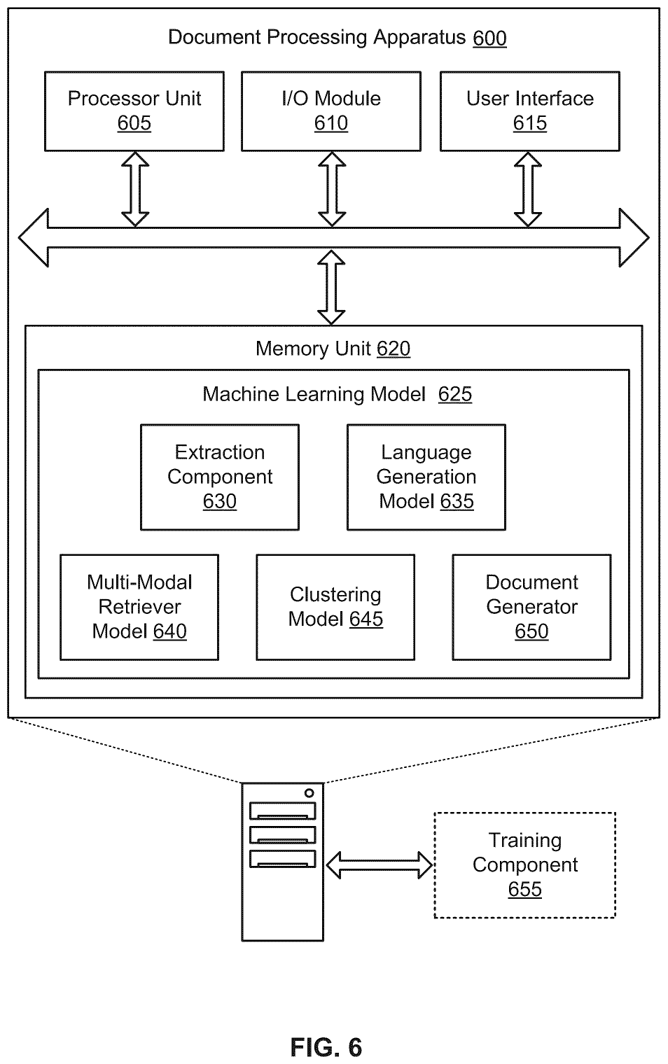

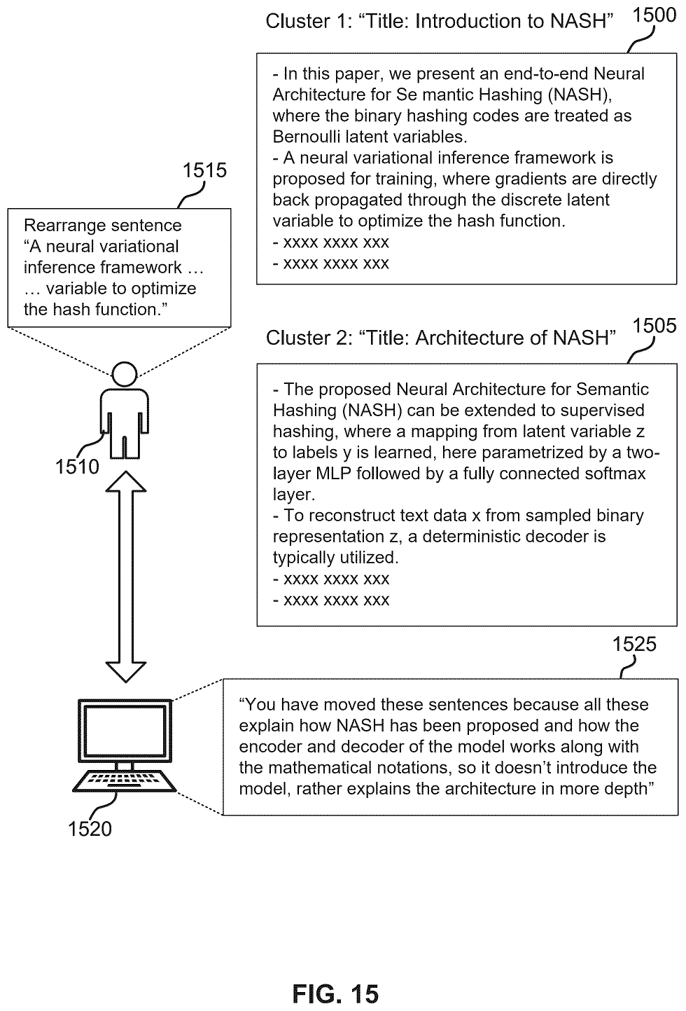

FIG. 1 shows an example of a document processing system according to aspects of the present disclosure. The example shown includes user 100, user device 105, document processing apparatus 110, cloud 115, and database 120. User 100 is an example of, or includes aspects of, the corresponding element described with reference to FIG. 15. Document processing apparatus 110 is an example of, or includes aspects of, the corresponding element described with reference to FIG. 6.

In an example shown in FIG. 1, a source document (e.g., .docx, .PDF format) is provided by user 100 and transmitted to document processing apparatus 110, e.g., via user device 105 and cloud 115. The source document includes multi-modal content (text, images, tables, charts, etc.). An extraction component is used to extract text and images from the source document. In some examples, the extracted content includes structured text comprising a set of sections.

In some examples, user 100 wants to transform the source document (e.g., an academic paper) into slide decks for presentation at a conference talk. User 100 wants to include more technical details in the output document for audience having sufficient background knowledge on the subject of the paper. In some cases, user 100 wants to market the idea or product in the paper to businesspersons. User 100 wants to include less technical details in the output document.

Document processing apparatus 110 obtains a source document and a user characteristic that indicates a complexity preference of a user. Document processing apparatus 110 generates, via a language generation model, a topic description based on the source document and the user characteristic, where the language generation model is trained based on an objective function that measures a complexity of the topic description. In some cases, document processing apparatus 110 generates, via the language generation model, multiple topics (or topic descriptions) based on the source document and the user characteristic. Additionally, document processing apparatus 110 retrieves content from the source document and places relevant content under each of the topics. The output document includes the text content. In some examples, the output document comprises a slide presentation including a set of slides corresponding to the set of topics, respectively. The wording of the topics in the output document may be different from the section titles in the source document.

Document processing apparatus 110 selects images from the source document and places the images to accompany a topic of a slide. Document processing apparatus 110 returns the output document to user 100 via cloud 115 and user device 105. The output document is of a format indicated by a file extension such as .pptx, .docx, .PDF, etc., and includes visually rich multi-modal content. In some examples, the output document spans multiple pages in length (e.g., multiple slides) and is relatively concise compared to the source document. The process of using document processing apparatus 110 is further described with reference to FIG. 2.

User device 105 may be a personal computer, laptop computer, mainframe computer, palmtop computer, personal assistant, mobile device, or any other suitable processing apparatus. In some examples, user device 105 includes software that incorporates a document processing application (e.g., a document summarization application, slides generator). In some examples, the text editing application on user device 105 may include functions of document processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Document processing apparatus 110 includes a computer implemented network comprising an extraction component, a language generation model, a multi-modal retriever model, an image selection component, an image generator, and a document generator. Document processing apparatus 110 may also include a processor unit, a memory unit, an I/O module, and a training component. The training component is used to train a machine learning model (or a document processing network). Additionally, document processing apparatus 110 can communicate with database 120 via cloud 115. In some cases, the architecture of the document processing network is also referred to as a network, a machine learning model, or a network model. Further detail regarding the architecture of document processing apparatus 110 is provided with reference to FIGS. 6-9. Further detail regarding the operation of document processing apparatus 110 is provided with reference to FIGS. 2 and 10-14.

In some cases, document processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., source documents, output documents) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, the database controller may operate automatically without user interaction.

FIG. 2 shows an example of a method 200 for processing a document to generate presentation slides according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the user provides a source document. In some cases, the operations of this step refer to, or may be performed by, a user as described with reference to FIGS. 1 and 15. In some examples, the source document includes multi-modal content (e.g., text, figures, tables, charts). In some examples, the source document is a technical document such as a paper submitted to a conference.

At operation 210, the system extracts content from the source document. In some cases, the operations of this step refer to, or may be performed by, a document processing apparatus as described with reference to FIGS. 1 and 6.

At operation 215, the system generates one or more topics based on the extracted content. In some cases, the operations of this step refer to, or may be performed by, a document processing apparatus as described with reference to FIGS. 1 and 6. In some examples, the user provides a complexity preference (e.g., topic length preference, output length preference, expertise level). Then the document processing apparatus generates the one or more topics based on the user-specified target audience and output length (e.g., number of slides).

In some cases, the document processing apparatus receives a skill level input via a user interface, where the skill level input indicates the predetermined skill level of a user. The document processing apparatus also receives a length input via the user interface, where the length input indicates the predetermined length of the output document.

At operation 220, the system generates an output document based on the one or more topics. In some cases, the operations of this step refer to, or may be performed by, a document processing apparatus as described with reference to FIGS. 1 and 6.

Automatic generation of presentations from a source document can assist the consumption of complex documents such as scientific articles or financial reports for users of different reading difficulty levels or communication needs. In some embodiments, the document processing apparatus transforms a source document into slide decks by generating a first draft of presentation targeting different types of audience (e.g., expert versus novice audience) and for short and long presentations. Additionally, an interactive interface provides a starting point to interactively edit a presentation based on how the user selects what content needs to be included and how the content should be aligned.

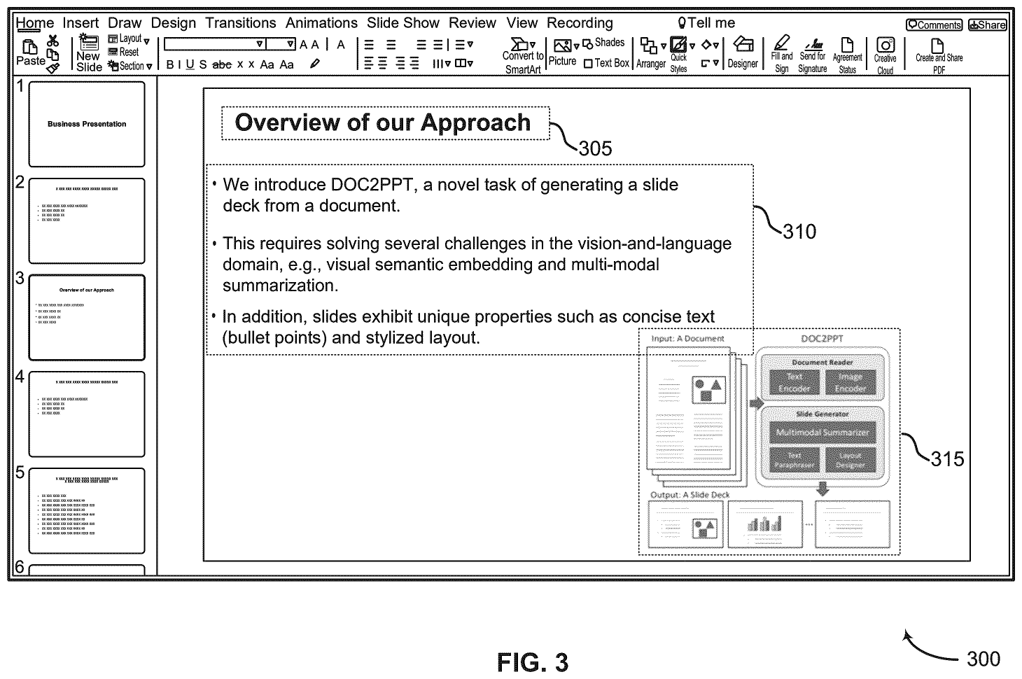

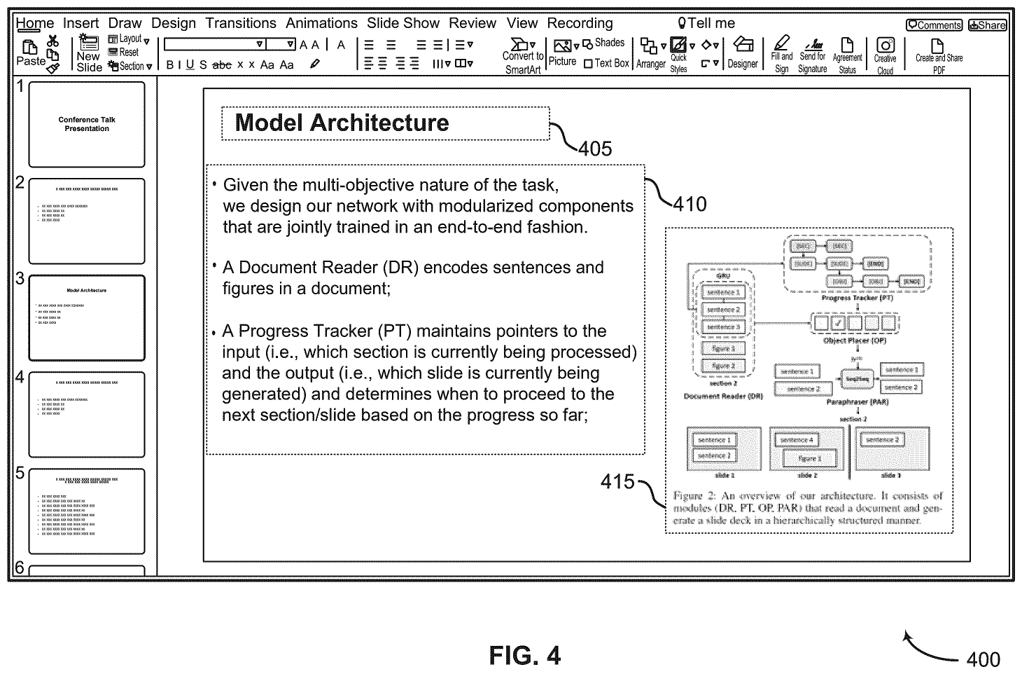

FIG. 3 shows an example of document-to-slides generation according to aspects of the present disclosure. The example shown includes output document 300, topic description 305, output section 310, and image 315. Output document 300 is an example of, or includes aspects of, the corresponding element described with reference to FIG. 4. In some examples, output document 300 includes a multi-modal presentation such as slides.

In some embodiments, topic description 305 depends on a user characteristic. The user characteristic indicates a complexity preference of the user (e.g., an expertise level). Additionally or alternatively, output section 310 and image 315 are retrieved based on the user characteristic. In an example shown in FIG. 3, a user selects a type of target audience, e.g., “Audience with no prior technical knowledge on the subject”. The generated topics include topic description 305, e.g., “Overview of our approach”. Output section 310 and image 315 are retrieved from a source document and placed under topic description 305.

Topic description 305 is an example of, or includes aspects of, the corresponding element described with reference to FIG. 4. Output section 310 is an example of, or includes aspects of, the corresponding element described with reference to FIG. 4. Image 315 is an example of, or includes aspects of, the corresponding element described with reference to FIG. 4.

FIG. 4 shows an example of document-to-slides generation according to aspects of the present disclosure. The example shown includes output document 400, topic description 405, output section 410, and image 415. Output document 400 is an example of, or includes aspects of, the corresponding element described with reference to FIG. 3. A machine learning model 625 (with reference to FIG. 6) generates output document 400 based on a source document (e.g., a PDF document).

In some embodiments, topic description 405 depends on a user characteristic. The user characteristic indicates a complexity preference of the user (e.g., an expertise level). Additionally or alternatively, output section 410 and image 415 are retrieved based on the user characteristic. In an example shown in FIG. 4, a user selects a type of target audience, e.g., “Audience with prior technical knowledge on the subject”. The generated topics include topic description 405, e.g., “Model Architecture”. Output section 410 and image 415 are retrieved from a source document and placed under topic description 405.

Topic description 405 is an example of, or includes aspects of, the corresponding element described with reference to FIG. 3. Output section 410 is an example of, or includes aspects of, the corresponding element described with reference to FIG. 3. Image 415 is an example of, or includes aspects of, the corresponding element described with reference to FIG. 3.

FIG. 5 shows an example of a method 500 for natural language processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains a source document. In some cases, the operations of this step refer to, or may be performed by, a language generation model as described with reference to FIGS. 6-8.

At operation 510, the system obtains a user characteristic that indicates a complexity preference of a user. In some cases, the operations of this step refer to, or may be performed by, a language generation model as described with reference to FIGS. 6-8.

In some embodiments, a document processing apparatus (with reference to FIGS. 1 and 6) is configured to perform interactive personalization and document-to-slides generation. A language generation model generates presentation outlines including a set of topics that are customized for the audience type (e.g., expert audience, novice audience). In some cases, users can edit an initial set of generated topics to obtain the set of topics (i.e., finalized set of topics). The language generation model learns from user feedback and is continuously updated based on the user feedback.

At operation 515, the system generates, using a language generation model, a topic description based on the source document and the user characteristic, where the language generation model is trained based on an objective function that measures a complexity of the topic description. In some cases, the operations of this step refer to, or may be performed by, a language generation model as described with reference to FIGS. 6-8. Additionally, users can customize the content to be extracted for showing it to audiences with varying type of persona. In some cases, users have flexibility to align the extracted content from the source document based on their goals using user-specified goal-driven clustering methods described in the present disclosure.

In some examples, updating the language generation model includes performing a reinforcement learning process (RL-policy based method) to generate an outline (a set of topics for an output document). In an embodiment, the document processing apparatus includes a personalized multi-modal retriever model (e.g., LlamaIndex Retriever) and a clustering model. The clustering model is a goal-driven interactive model for aligning extracted content from a source document with topics based on user goals.

The document processing apparatus models user preferences in transforming a source document into an output document (e.g., slide decks). The document processing apparatus takes the type of target audience as input, e.g., audience having prior knowledge of the subject versus audience having no prior knowledge of the subject. Additionally or alternatively, the document processing apparatus takes the length of the presentation as input, and selects important topics and content depending on the size of the presentation (short presentation or long presentation).

In some embodiments, the language generation model is trained using reinforcement learning with user feedback to learn to selectively extract a topic outline from the source document. In some cases, the language generation model takes a specific type of target audience as input. Then a personalized topic-based multi-modal content retriever extracts or generates content based on the set of topics. In some cases, the topic-based multi-modal content retriever is also referred to as a multi-modal retriever model.

In some embodiments, an interactive goal-driven clustering model is used to render the extracted content from the source document based on how a user wants to arrange and align the extracted content for presentation. For example, the user wants to display the results of the proposed system (as mentioned in the source document) based on 1) dataset-wise performance or 2) task-wise performance or 3) performance evaluation using automatic measures or human judgement. The user can, via the clustering model, re-cluster the content and provide constraints on effectively clustering the content extracted from the topic-based multi-modal content retriever. The clustering model iteratively learns from user feedback.

In some examples, the multi-modal retriever model extracts multi-modal content for generating slide decks and the output content (e.g., titles, section content, length) is updated and adjusted based on user characteristics (e.g., expert versus novice audience). In some examples, a user can customize the topic outline for different audience types and length of the output presentation using an interactive and personalized editing interface.

### Network Architecture

In FIGS. 6-9, an apparatus and method for natural language processing are described. One or more embodiments of the apparatus and method include at least one processor; at least one memory including instructions executable by the at least one processor; a language generation model comprising parameters stored in the at least one memory and trained to generate a topic description based on a source document and a user characteristic; and a clustering model comprising parameters stored in the at least one memory and trained to cluster a plurality of sentences of the source document to obtain a plurality of clustered sentences corresponding to the topic description.

Some examples of the apparatus and method further include an extraction component configured to extract text from the source document. Some examples of the apparatus and method further include a user interface configured to receive feedback on the topic description or the plurality of clustered sentences. In some examples, the language generation model and the clustering model each comprises a transformer network.

FIG. 6 shows an example of a document processing apparatus 600 according to aspects of the present disclosure. The example shown includes document processing apparatus 600, processor unit 605, I/O module 610, user interface 615, memory unit 620, machine learning model 625, and training component 655. Document processing apparatus 600 is an example of, or includes aspects of, the corresponding element described with reference to FIG. 1. User interface 615 is an example of, or includes aspects of, the corresponding element described with reference to FIGS. 3, 4, 8, 10, and 12-14.

In some examples, document processing apparatus 600 can generate a topic outline and edit the topic outline based on user feedback. Document processing apparatus 600 is configured to perform content alignment from one slide to another. Document processing apparatus 600 takes user characteristic (that indicates a complexity preference of a user) and generates slide decks from a source document based on the user characteristic.

Processor unit 605 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 605 is configured to operate a memory array using a memory controller. In other cases, a memory controller is integrated into the processor. In some cases, processor unit 605 is configured to execute computer-readable instructions stored in a memory to perform various functions. In some embodiments, processor unit 605 includes special purpose components for modem processing, baseband processing, digital signal processing, or transmission processing.

Examples of memory unit 620 include random access memory (RAM), read-only memory (ROM), or a hard disk. Examples of memory unit 620 include solid state memory and a hard disk drive. In some examples, memory unit 620 is used to store computer-readable, computer-executable software including instructions that, when executed, cause a processor to perform various functions described herein. In some cases, memory unit 620 contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within memory unit 620 store information in the form of a logical state.

In some examples, at least one memory unit 620 includes instructions executable by at least one processor unit 605. Memory unit 620 includes machine learning model 625 or stores parameters of machine learning model 625.

I/O module 610 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 610 includes a user interface. A user interface may enable a user to interact with a device. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments of the present disclosure, document processing apparatus 600 includes a computer implemented artificial neural network (ANN) for natural language processing (e.g., summarization, text prediction, clustering). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

Accordingly, during the training process, the parameters and weights of the machine learning model 625 are adjusted to increase the accuracy of the result (i.e., by attempting to minimize a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some embodiments, document processing apparatus 600 includes a convolutional neural network (CNN). CNN is a class of neural networks that is commonly used in computer vision or image classification systems. In some cases, a CNN may enable the processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Natural language processing (NLP) refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. These models can express the relative probability of multiple answers.

According to some embodiments, training component 655 initializes parameters of machine learning model 625. Training component 655 is used to train or fine-tune language generation model 635 and clustering model 645. In some cases, training component 655 (shown in dashed line) is implemented on an apparatus other than document processing apparatus 700.

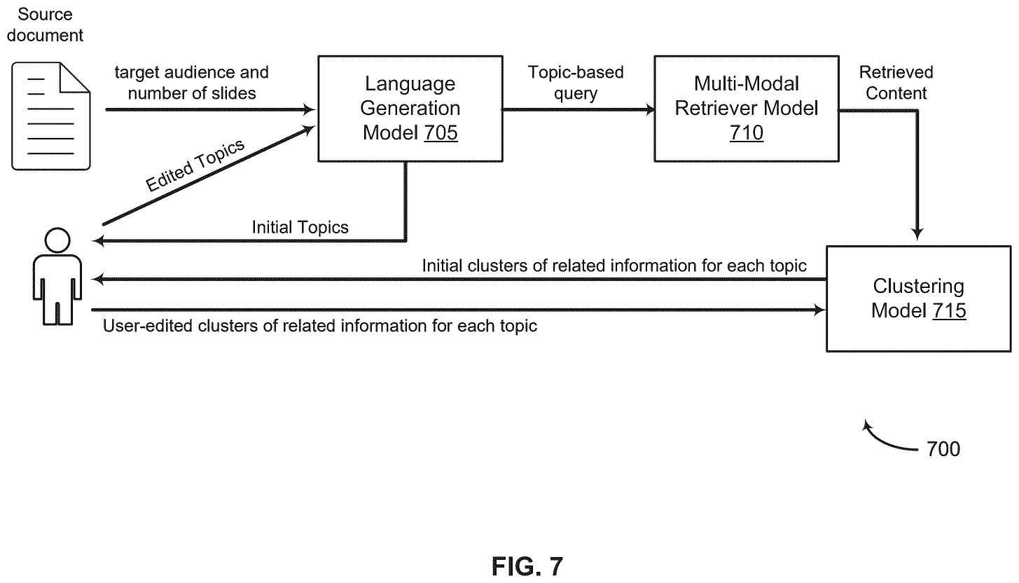

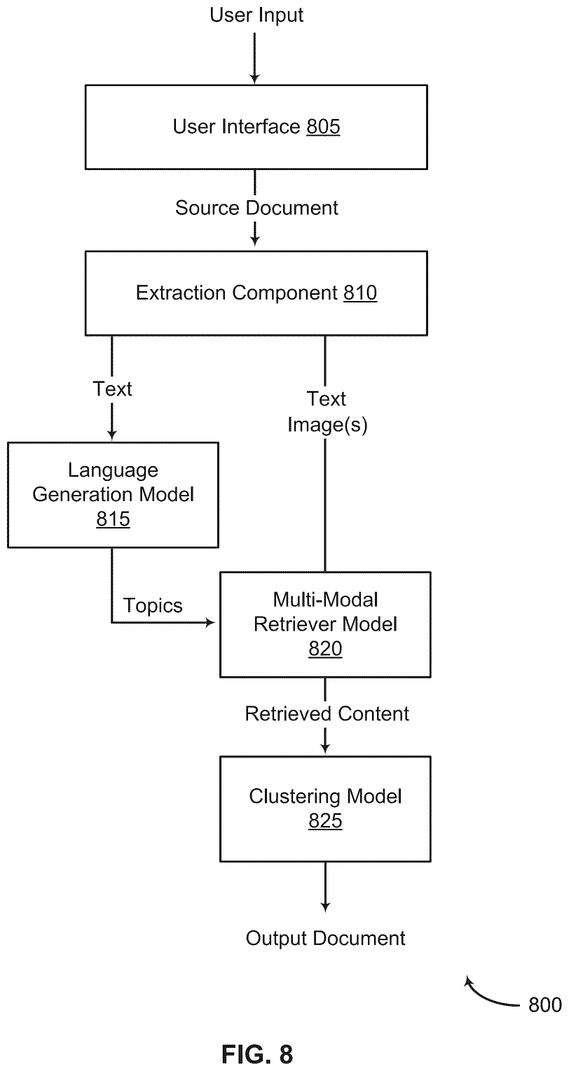

Machine learning model 625 is an example of, or includes aspects of, the corresponding element described with reference to FIGS. 7 and 8. In one embodiment, machine learning model 625 includes extraction component 630, language generation model 635, multi-modal retriever model 640, clustering model 645, and document generator 650.

According to some embodiments, extraction component 630 is configured to extract text from the source document. Extraction component 630 is an example of, or includes aspects of, the corresponding element described with reference to FIG. 8. In some examples, extraction component 630 extracts structured text from the source document, where the structured text includes a set of source sections. In some examples, extraction component 630 extracts an image from the source document.

According to some embodiments, language generation model 635 obtains a source document. In some examples, language generation model 635 obtains a user characteristic that indicates a complexity preference of a user. In some examples, language generation model 635 generates a topic description based on the source document and the user characteristic, where the language generation model 635 is trained based on an objective function that measures a complexity of the topic description.

In some examples, the complexity preference includes a topic length preference or an expertise level of the user. In some examples, a prompt is generated based on the user characteristic and the prompt is fed to the language generation model 635, where the topic description is generated based on the prompt. In some examples, language generation model 635 generates an output document based on the topic description.

In some examples, a prompt including instructions to generate the output document is generated and the prompt is fed to language generation model 635. In some examples, language generation model 635 generates a set of topics. In some examples, language generation model 635 obtains a multi-media asset based on the topic description, where the output document includes the multi-media asset.

According to some embodiments, language generation model 635 obtains a source document. In some examples, language generation model 635 generates a topic description based on the source document. In some examples, language generation model 635 generates a set of topic descriptions based on the source document, where the objective function is based on a number of the set of topic descriptions. In some examples, language generation model 635 obtains a user characteristic that indicates a complexity preference of a user, where the topic description is generated based on the complexity preference.

According to some embodiments, the language generation model 635 comprising parameters stored in the at least one memory is trained to generate a topic description based on a source document and a user characteristic. In some examples, the language generation model 635 and the clustering model 645 each includes a transformer network. Language generation model 635 is an example of, or includes aspects of, the corresponding element described with reference to FIGS. 7 and 8. Multi-modal retriever model 640 is an example of, or includes aspects of, the corresponding element described with reference to FIGS. 7 and 8.

According to some embodiments, clustering model 645 clusters a set of sentences from the source document based on the set of topics, where the output document is based on the clustering.

According to some embodiments, clustering model 645 clusters a set of sentences of the source document to obtain a set of clustered sentences. In some examples, clustering model 645 receives user feedback based on the set of clustered sentences. In some examples, clustering model 645 generates a description of an intent of the user feedback. In some examples, clustering model 645 receives a modified description of the intent of the user feedback.

According to some embodiments, clustering model 645 comprising parameters stored in the at least one memory is trained to cluster a plurality of sentences of the source document to obtain a plurality of clustered sentences corresponding to the topic description. Clustering model 645 is an example of, or includes aspects of, the corresponding element described with reference to FIGS. 7, 8, and 15.

According to some embodiments, training component 655 computes an objective function that measures a complexity of the topic description. In some examples, training component 655 updates the language generation model 635 based on the objective function. In some examples, the objective function is based on a percentage of technical words in the topic description or a percentage of technical topic descriptions. In some examples, training component 655 performs a reinforcement learning process based on the objective function. In some examples, training component 655 updates parameters of the clustering model 645 based on the user feedback.

In some examples, training component 655 computes a likelihood loss based on the modified description of the intent. Training component 655 updates the parameters of the clustering model 645 based on the likelihood loss. In some cases, training component 655 (shown in dashed line) is implemented on an apparatus other than document processing apparatus 600.

FIG. 7 shows an example of a machine learning model 700 for text processing according to aspects of the present disclosure. The example shown includes machine learning model 700, language generation model 705, multi-modal retriever model 710, and clustering model 715. Machine learning model 700 is an example of, or includes aspects of, the corresponding element described with reference to FIGS. 6 and 8.

In some embodiments, machine learning model 700 takes a source document as input and performs document transformation to obtain an outline of the transformed document. Machine learning model 700 is configured to choose a set of important topics or titles/subtitles for content of the source document and the order in which users would prefer the presentation of topics should look like. In some cases, scientific documents include sections and paragraphs, however, the output document (e.g., presentation slides) need not contain the same mappings of section to content as present in the source document. Machine learning model 700, via a customized topic recommendation algorithm, is configured to recommend topics to the users depending on user-specified target audience and number of slides. A user iteratively chooses their preferences on top of the model suggestions, hence providing feedback to machine learning model 700 to customize its parameters towards user preferences.

In an embodiment, machine learning model 700 includes language generation model 705, multi-modal retriever model 710, and clustering model 715. Inputs to language generation model 705 include a source document (e.g., PDF format), type of target audience, and length of presentation (e.g., number of slides in the output). Language generation model 705 generates an output comprising a set of important topics from the source document aligning with target user preferences and length of the presentation. In some examples, language generation model 705 generates a set of initial topics. A user (represented by a user icon) provides a set of edited topics that are sent back to language generation model 705 for processing. In some cases, language generation model 705 may be referred to as a topic generator. Language generation model 705 is an example of, or includes aspects of, the corresponding element described with reference to FIGS. 6 and 8.

In an embodiment, multi-modal retriever model 710 is configured to retrieve the most relevant multi-modal content from the source document based on the final topics, target audience type, and length of the presentation. In some examples, multi-modal retriever model 710 receives a topic-based query as input and multi-modal retriever model 710 outputs retrieved content. In some cases, multi-modal retriever model 710 is also referred to as a multi-modal content retriever. Multi-modal retriever model 710 is an example of, or includes aspects of, the corresponding element described with reference to FIGS. 6 and 8.

In an embodiment, clustering model 715 performs goal-driven content alignment (clustering/re-ranker). At this step, clustering model 715 obtains personalized content extracted from the source document for each topic or title. The content needs to be correctly aligned to suit the needs of users, such that it optimizes the need of how the users should prefer skimming through the content. Moreover, clustering model 715 is configured to perform image-text alignment, where users can provide feedback or instructions to the clustering model to align the correct images, tables, and text in each content topic.

In some examples, clustering model 715 generates initial clusters of related information for each topic in the set of topics. A user (represented by the user icon) receives the initial clusters and provides user-edited clusters of related information for each topic in the set of topics. The user-edited clusters are then sent back to clustering model 715 for processing. Clustering model 715 is an example of, or includes aspects of, the corresponding element described with reference to FIGS. 6, 8, and 15.

FIG. 8 shows an example of a machine learning model 800 for text processing according to aspects of the present disclosure. The example shown includes machine learning model 800, user interface 805, extraction component 810, language generation model 815, multi-modal retriever model 820, and clustering model 825. Machine learning model 800 is an example of, or includes aspects of, the corresponding element described with reference to FIGS. 6 and 7.

In an embodiment, a user, via user interface 805, selects complexity preference including a topic length preference (e.g., length of output document, number of presentation slides) and/or an expertise level of the user (e.g., expert, novice). The user, via user interface 805, selects or uploads a source document for processing and transformation. User interface 805 is an example of, or includes aspects of, the corresponding element described with reference to FIGS. 3, 4, 6, 10, and 12-14.

Extraction component 810 takes the source document as input (e.g., a scientific paper). Extraction component 810 extracts text from the source document. In some cases, different content may be useful to different types of users. That is, retrieved content from the source document depends on the target audience. In some embodiments, machine learning model 800 includes multi-modal retriever model 820 that selects which content to use in the output slides.

In some examples, multi-modal retriever model 820 includes a LLAMA-Index based task-aware retrieval network. Multi-modal retriever model 820 takes a prompt (e.g., one or more topic descriptions) as input. Multi-modal retriever model 820 uses one or more prompts to build the index, do insertion, perform traversal during querying, and to synthesize a final answer. The multi-modal retriever model 820 includes a retriever network and a re-ranker network that prioritize the content based on target audience and/or length of the presentation. Multi-modal retriever model 820 performs content retrieval by taking into account user expertise level and the length of presentation.

In some examples, extraction component 810 includes PDFFigures 2.0 extraction tool which extracts figures, tables, captions, and section titles from a source document (e.g., PDF). Extraction component 810 extracts figures and captions from the source document and provides a one-to-one mapping from an image in the source document to its corresponding manually written description. Extraction component 810 is an example of, or includes aspects of, the corresponding element described with reference to FIG. 6.

In some examples, extraction component 810 includes PDFFigures 2.0. Extraction component 810 is configured to extract figures, captions, tables and section titles from scholarly documents. To represent the multi-modal content in the source document, extraction component 810 represents the images and tables in the source document by its textual description or captions. Thus, multi-modal retriever model 820 takes as input both the textual sentences/paragraphs in the source document and captions of tables/figures to index. Then multi-modal retriever model 820 uses the topics as prompts along with type of audience and length of the presentation to query top-K relevant textual content pertaining to the query. Multi-modal retriever model 820 is an example of, or includes aspects of, the corresponding element described with reference to FIGS. 6 and 7.

Language generation model 815 generates a set of topics based on the source document and a user characteristic. A topic of the set of topics may be referred to as a topic description. The user characteristic indicates a complexity preference of the user and is obtained via user interface 805. Language generation model 815 is an example of, or includes aspects of, the corresponding element described with reference to FIGS. 6 and 7.

In some embodiments, clustering model 825 clusters a set of sentences of the source document to obtain a set of clustered sentences (e.g., a first cluster, a second cluster, a third cluster, etc). The clustering model 825 ensures content extracted from the source document is arranged and placed under an appropriate topic of the topics. The content is correctly aligned to suit the needs of the user. Clustering model 825 is an example of, or includes aspects of, the corresponding element described with reference to FIGS. 6, 7, and 15.

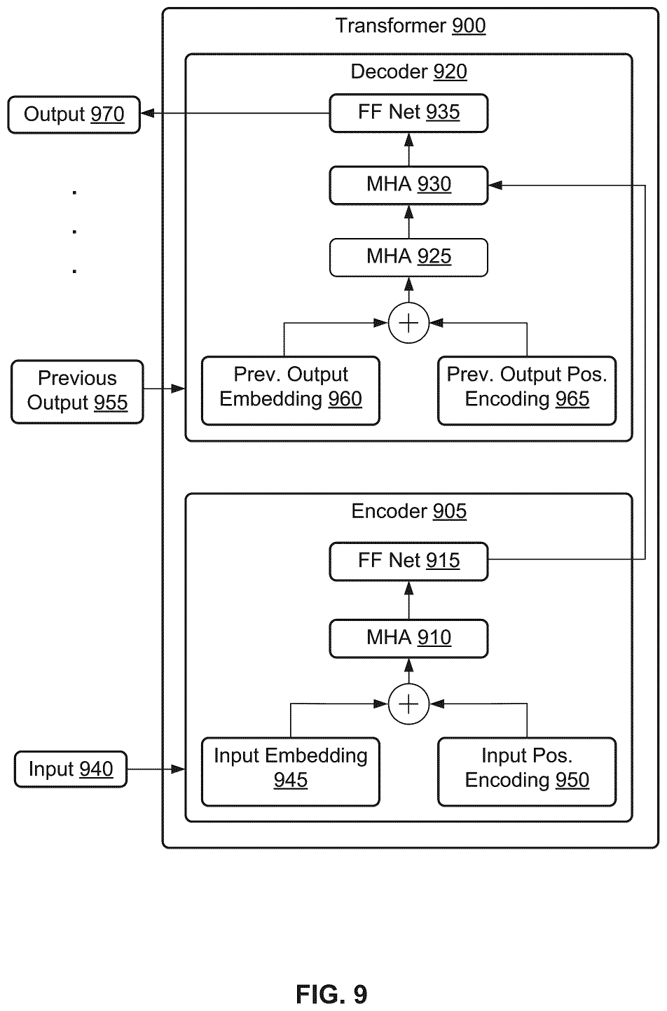

FIG. 9 shows an example of a transformer network according to aspects of the present disclosure. The example shown includes transformer 900, encoder 905, decoder 920, input 940, input embedding 945, input positional encoding 950, previous output 955, previous output embedding 960, previous output positional encoding 965, and output 970.

In some cases, encoder 905 includes multi-head self-attention sublayer 910 and feed-forward network sublayer 915. In some cases, decoder 920 includes first multi-head self-attention sublayer 925, second multi-head self-attention sublayer 930, and feed-forward network sublayer 935.

According to some aspects, a machine learning model (such as the machine learning model described with reference to FIGS. 6, 7, and 8) comprises transformer 900. In some cases, encoder 905 is configured to map input 940 (for example, a query or a prompt comprising a sequence of words or tokens) to a sequence of continuous representations that are fed into decoder 920. In some cases, decoder 920 generates output 970 (e.g., a prediction of an output sequence of words or tokens) based on the output of encoder 905 and previous output 955 (e.g., a previously predicted output sequence), which allows for the use of autoregression.

For example, in some cases, encoder 905 parses input 940 into tokens and vectorizes the parsed tokens to obtain input embedding 945, and adds input positional encoding 950 (e.g., positional encoding vectors for input 940 of a same dimension as input embedding 945) to input embedding 945. In some cases, input positional encoding 950 includes information about relative positions of words or tokens in input 940.

In some cases, encoder 905 comprises one or more encoding layers (e.g., six encoding layers) that generate contextualized token representations, where each representation corresponds to a token that combines information from other input tokens via self-attention mechanism. In some cases, each encoding layer of encoder 905 comprises a multi-head self-attention sublayer (e.g., multi-head self-attention sublayer 910). In some cases, the multi-head self-attention sublayer implements a multi-head self-attention mechanism that receives different linearly projected versions of queries, keys, and values to produce outputs in parallel. In some cases, each encoding layer of encoder 905 also includes a fully connected feed-forward network sublayer (e.g., feed-forward network sublayer 915) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 940.

In some cases, each sublayer of encoder 905 is followed by a normalization layer that normalizes a sum computed between a sublayer input x and an output sublayer (x) generated by the sublayer:

$$layernorm ( x + sublayer ( x ) ) \qquad ( 2 )$$

In some cases, encoder 905 is bidirectional because encoder 905 attends to each word or token in input 940 regardless of a position of the word or token in input 940.

In some cases, decoder 920 comprises one or more decoding layers (e.g., six decoding layers). In some cases, each decoding layer comprises three sublayers including a first multi-head self-attention sublayer (e.g., first multi-head self-attention sublayer 925), a second multi-head self-attention sublayer (e.g., second multi-head self-attention sublayer 930), and a feed-forward network sublayer (e.g., feed-forward network sublayer 935). In some cases, each sublayer of decoder 920 is followed by a normalization layer that normalizes a sum computed between a sublayer input x and an output sublayer (x) generated by the sublayer.

In some cases, decoder 920 generates previous output embedding 960 of previous output 855 and adds previous output positional encoding 965 (e.g., position information for words or tokens in previous output 955) to previous output embedding 960. In some cases, each first multi-head self-attention sublayer receives the combination of previous output embedding 960 and previous output positional encoding 965 and applies a multi-head self-attention mechanism to the combination. In some cases, for each word in an input sequence, each first multi-head self-attention sublayer of decoder 920 attends only to words preceding the word in the sequence, and so transformer 900's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 905 by receiving a query Q from a previous sublayer of decoder 920 and a key K and a value V from the output of encoder 905, allowing decoder 920 to attend to each word in the input 940.

In some cases, each feed-forward network sublayer implements a fully connected feed-forward network similar to feed-forward network sublayer 915. In some cases, the feed-forward network sublayers are followed by a linear transformation and a softmax to generate a prediction of output 970 (e.g., a prediction of a next word or token in a sequence of words or tokens). Accordingly, in some cases, transformer 900 generates a response as described herein based on a predicted sequence of words or tokens.

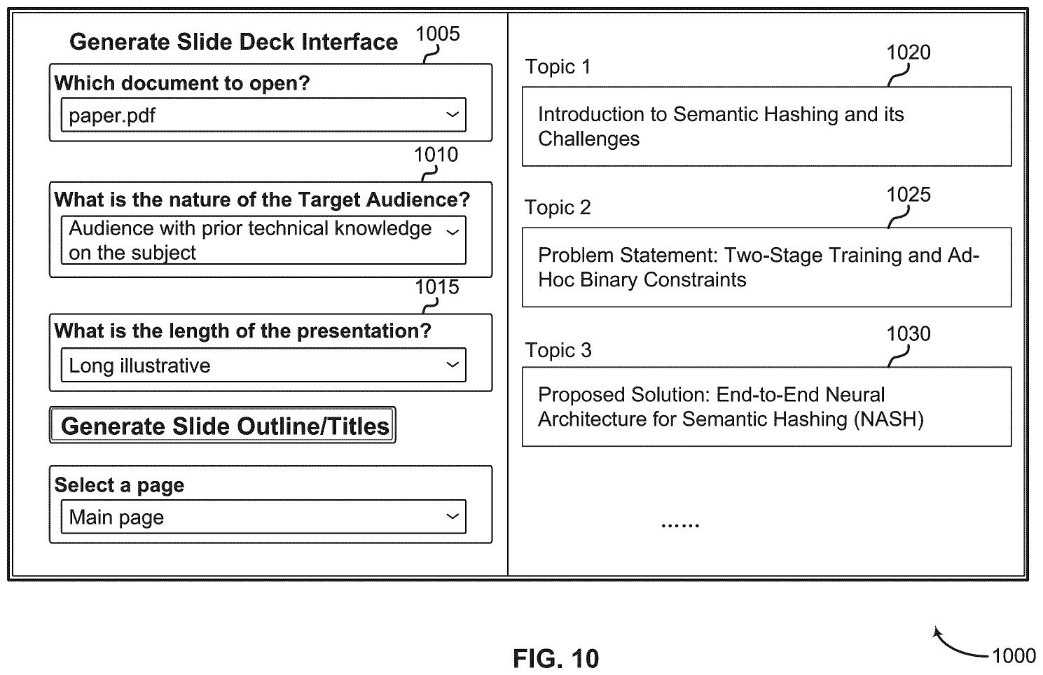

FIG. 10 shows an example of a user interface 1000 according to aspects of the present disclosure. The example shown includes user interface 1000, document selection element 1005, expertise level element 1010, length preference element 1015, first topic 1020, second topic 1025, and third topic 1030.

According to some embodiments, user interface 1000 includes document selection element 1005, expertise level element 1010, length preference element 1015. A user uploads a source document (e.g., filename “paper.pdf”) by clicking document selection element 1005. The user can select a type of target audience via expertise level element 1010 to indicate an expertise level of the target audience. For example, the expertise level is set to “Audience with prior technical knowledge on the subject”. Here, the target audience may include engineers and scientists who possess sufficient knowledge on the subject. In some cases, the expertise level is set to “Audience with no prior technical knowledge on the subject”. The user selects, via length preference element 1015, “Long illustrative” type to indicate a target length of the output document.

According to some embodiments, the user clicks on “Generate slide outline/titles” button and then user interface 1000 displays one or more topic descriptions to the user. A language generation model in the backend (with reference to FIG. 6) generates first topic 1020, second topic 1025, and third topic 1030 based on the source document. User interface 1000 displays first topic 1020, second topic 1025, and third topic 1030. In some examples, user interface 1000 receives feedback from the user based on the one or more topic descriptions. The user can modify one of the generated topics (i.e., topics initially generated). User interface 1000 is an example of, or includes aspects of, the corresponding element described with reference to FIGS. 3, 4, 6, 8, and 12-14.

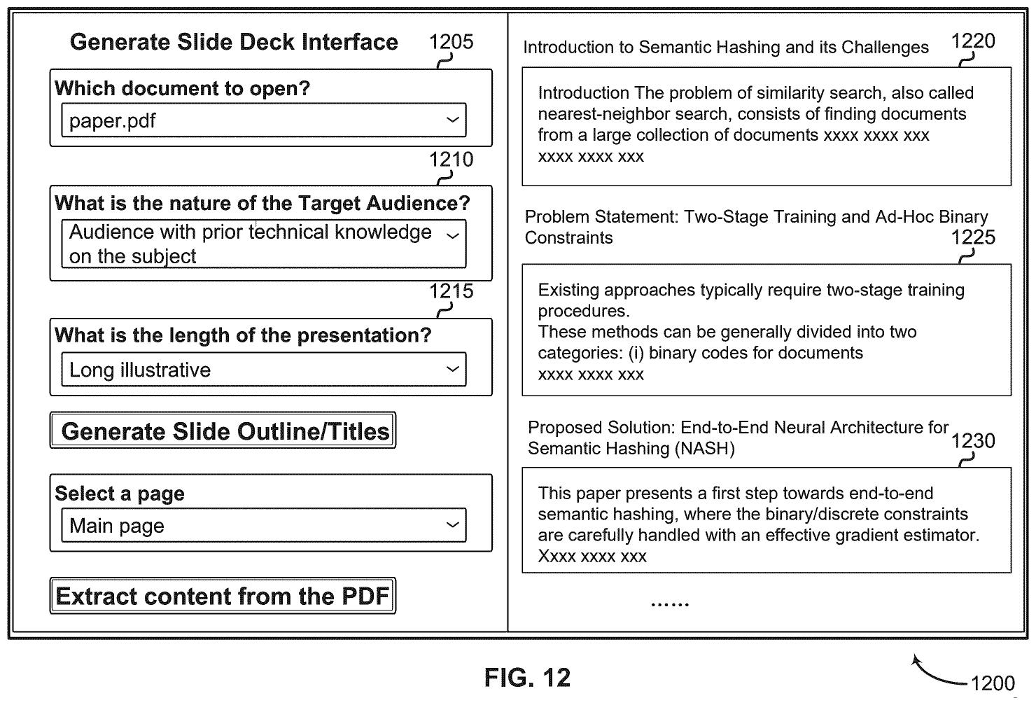

Document selection element 1005 is an example of, or includes aspects of, the corresponding element described with reference to FIG. 12. Expertise level element 1010 is an example of, or includes aspects of, the corresponding element described with reference to FIG. 12. Length preference element 1015 is an example of, or includes aspects of, the corresponding element described with reference to FIG. 12.

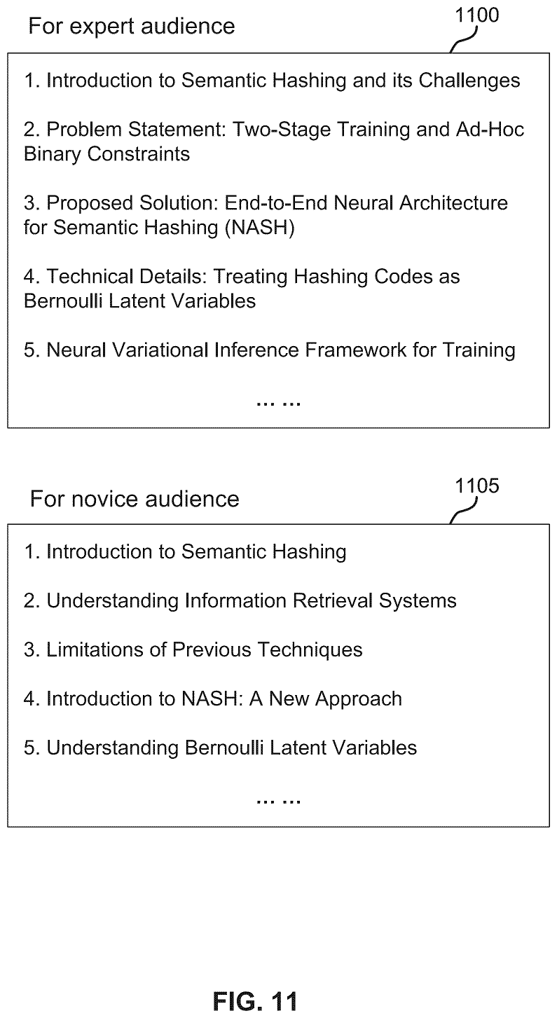

FIG. 11 shows an example of topic descriptions according to aspects of the present disclosure. The example shown includes first set of topics 1100 and second set of topics 1105.

In some examples, a prompt is generated based on the user characteristic and the prompt is fed to a language generation model (with reference to language generation model 635). A set of topics (or topic descriptions) is generated based on the prompt. An example of a prompt is “Here is the title ‘+str (title)+’ and abstract ‘+str(abstract)+’ of the source document in the following use case where I want to present the paper to the non-technical audience who cares mostly about the overall impact of the solution approach in the research paper. They don't understand any of the technical jargons used in the literature of machine learning and natural language processing tasks, in this case can you make presentation slides which is long. Format your response as JSON Object with keys as paperID and topics.” The language generation model generates first set of topics 1100 and second set of topics 1105 based on a source document (e.g., an academic paper).

In an example shown in FIG. 11, the language generation model generates first set of topics 1100 based on an expertise level of a first user. The first user belongs to expert audience category. The first set of topics 1100 includes (1) Introduction to Semantic Hashing and its Challenges; (2) Problem Statement: Two-Stage Training and Ad-Hoc Binary Constraints; (3) Proposed Solution: End-to-End Neural Architecture for Semantic Hashing (NASH); (4) Technical Details: Treating Hashing Codes as Bernoulli Latent Variables; (5) Neural Variational Inference Framework for Training; (6) Connection between NASH and Rate-Distortion Theory; (7) Experimental Setup and Datasets; (8) Results: Performance of NASH in Unsupervised and Supervised Scenarios; (9) Impact: Advantages of NASH over State-of-the-Art Models; and (10) Conclusion and Future Work.

The language generation model generates the first set of topics 1100 based on an expertise level of a second user or selected by the second user. The second user belongs to novice audience category. Second set of topics 1105 includes (1) Introduction to Semantic Hashing; (2) Understanding Information Retrieval Systems; (3) Limitations of Previous Techniques; (4) Introduction to NASH: A New Approach; (5) Understanding Bernoulli Latent Variables; (6) Training with Neural Variational Inference; (7) Connection to Rate-Distortion Theory; (8) Experimental Results and Comparisons; (9) Impact in General; (10) Conclusion and Future Directions.

FIG. 12 shows an example of user interface 1200 according to aspects of the present disclosure. The example shown includes user interface 1200, document selection element 1205, expertise level element 1210, length preference element 1215, first output section 1220, second output section 1225, and third output section 1230. User interface 1200 is an example of, or includes aspects of, the corresponding element described with reference to FIGS. 3, 4, 6, 8, 10, 13, and 14.

In an embodiment, user interface 1200 includes and displays document selection element 1205, expertise level element 1210, length preference element 1215. A user clicks on “Extract content from the PDF” button and then user interface 1200 displays a set of output sections corresponding to the generated topics (in FIG. 10), respectively. The set of output sections includes first output section 1220, second output section 1225, and third output section 1230.

Document selection element 1205 is an example of, or includes aspects of, the corresponding element described with reference to FIG. 10. Expertise level element 1210 is an example of, or includes aspects of, the corresponding element described with reference to FIG. 10. Length preference element 1215 is an example of, or includes aspects of, the corresponding element described with reference to FIG. 10.

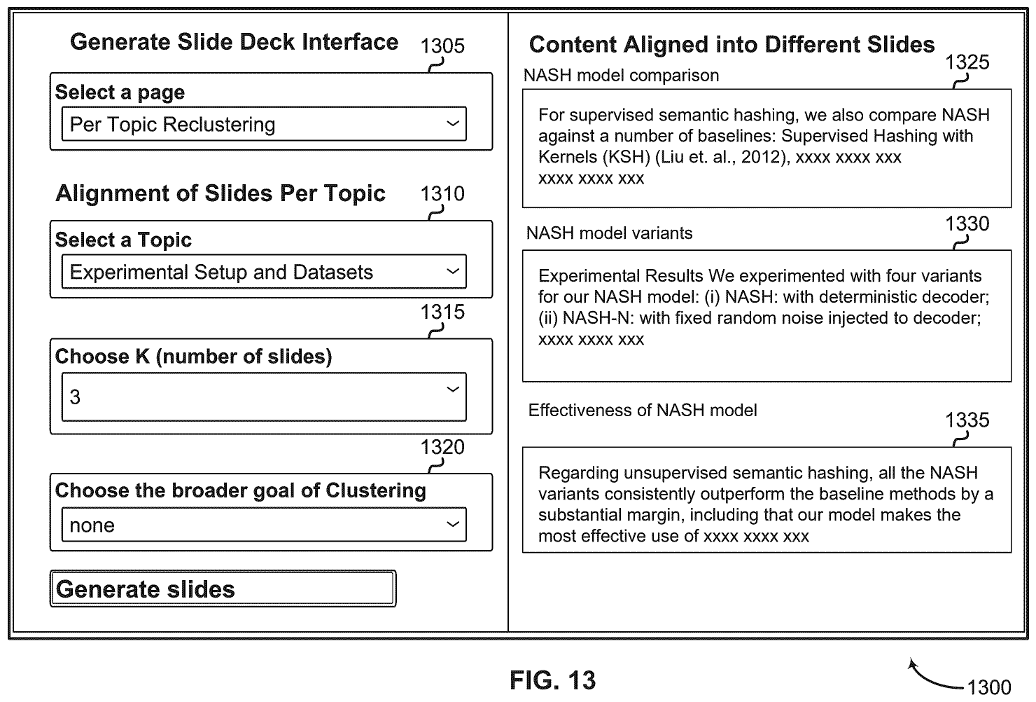

FIG. 13 shows an example of a user interface 1300 according to aspects of the present disclosure. The example shown includes user interface 1300, page selection element 1305, topic selection element 1310, clustering size element 1315, clustering objective preference element 1320, first cluster 1325, second cluster 1330, and third cluster 1335. User interface 1300 is an example of, or includes aspects of, the corresponding element described with reference to FIGS. 3, 4, 6, 8, 10, 12, and 14.

According to some embodiments, user interface 1300 includes page selection element 1305, topic selection element 1310, clustering size element 1315, clustering objective preference element 1320. In some examples, a user selects “Per topic reclustering” via page selection element 1305 on user interface 1300. The user chooses, via topic selection element 1310, a section named “Experimental Setup and Datasets”. The user selects number of slides (value of K) via clustering size element 1315. The user selects “none” for the broader goal of clustering via clustering objective preference element 1320. The user then clicks on the “Generate slides” button on user interface 1300.

According to some embodiments, user interface 1300 displays a set of clusters. A cluster of the set of clusters includes one or more sentences. For example, user interface 1300 displays three clusters including first cluster 1325, second cluster 1330, and third cluster 1335. The value of number of slides is set to 3 by the user via clustering size element 1315. Accordingly, three clusters are generated. In some cases, user interface 1300 is configured to receive feedback on the topic description and/or the plurality of clustered sentences. The user can edit text in a cluster of sentences. The user can move a sentence from a cluster to another cluster.

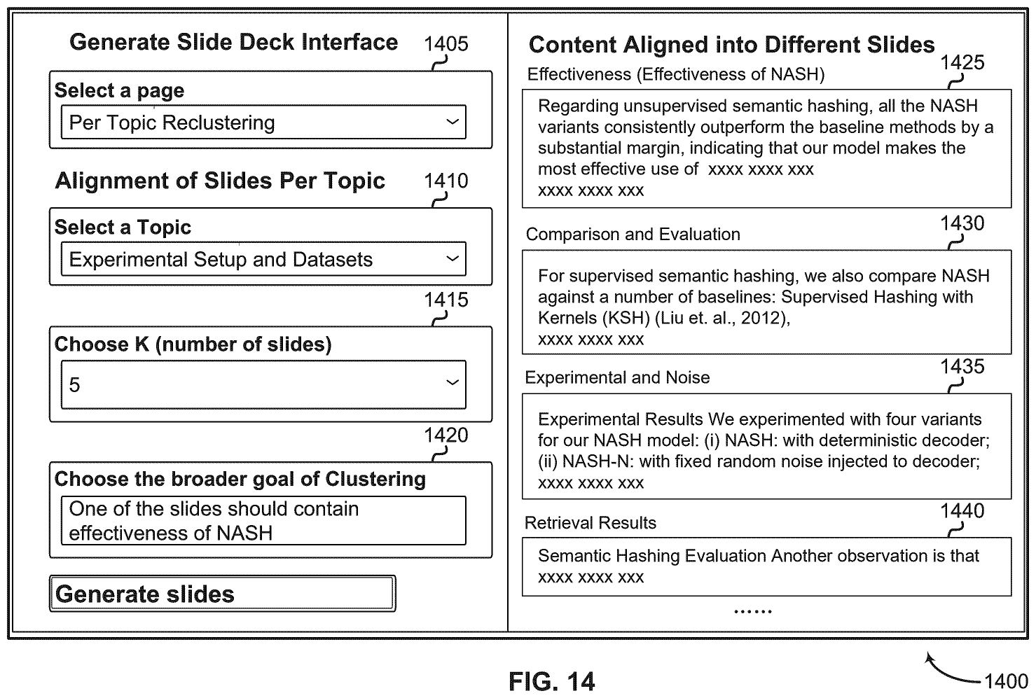

Page selection element 1305 is an example of, or includes aspects of, the corresponding element described with reference to FIG. 14. Topic selection element 1310 is an example of, or includes aspects of, the corresponding element described with reference to FIG. 14. Clustering size element 1315 is an example of, or includes aspects of, the corresponding element described with reference to FIG. 14. Clustering objective preference element 1320 is an example of, or includes aspects of, the corresponding element described with reference to FIG. 14.

First cluster 1325 is an example of, or includes aspects of, the corresponding element described with reference to FIGS. 14 and 15. Second cluster 1330 is an example of, or includes aspects of, the corresponding element described with reference to FIGS. 14 and 15. Third cluster 1335 is an example of, or includes aspects of, the corresponding element described with reference to FIG. 14.

FIG. 14 shows an example of a user interface 1400 according to aspects of the present disclosure. The example shown includes user interface 1400, page selection element 1405, topic selection element 1410, clustering size element 1415, clustering objective preference element 1420, first cluster 1425, second cluster 1430, third cluster 1435, and fourth cluster 1440. User interface 1400 is an example of, or includes aspects of, the corresponding element described with reference to FIGS. 3, 4, 6, 8, 10, 12, and 13.

According to some embodiments, user interface 1400 includes page selection element 1405, topic selection element 1410, clustering size element 1415, clustering objective preference element 1420. In some examples, a user selects “Per topic reclustering” via page selection element 1405 on user interface 1400. The user chooses, via topic selection element 1410, a section named “Experimental Setup and Datasets”. The user selects number of slides (value of K) via clustering size element 1415. The user enters “One of the slides should contain effectiveness of NASH” for the broader goal of clustering via clustering objective preference element 1420. The user then clicks on “Generate slides” button on user interface 1400.

According to some embodiments, user interface 1400 displays a set of clusters. A cluster of the set of clusters includes one or more sentences. For example, user interface 1400 displays five clusters including first cluster 1425, second cluster 1430, third cluster 1435, and fourth cluster 1440. The value of number of slides is set to 5 by the user via clustering size element 1415. Accordingly, five clusters are generated. In some cases, user interface 1400 is configured to receive feedback on the plurality of clustered sentences. The user can edit text in a cluster of sentences. The user can move a sentence from a cluster to another cluster.

Page selection element 1405 is an example of, or includes aspects of, the corresponding element described with reference to FIG. 13. Topic selection element 1410 is an example of, or includes aspects of, the corresponding element described with reference to FIG. 13. Clustering size element 1415 is an example of, or includes aspects of, the corresponding element described with reference to FIG. 13. Clustering objective preference element 1420 is an example of, or includes aspects of, the corresponding element described with reference to FIG. 13.

First cluster 1425 is an example of, or includes aspects of, the corresponding element described with reference to FIGS. 13 and 15. Second cluster 1430 is an example of, or includes aspects of, the corresponding element described with reference to FIGS. 13 and 15. Third cluster 1435 is an example of, or includes aspects of, the corresponding element described with reference to FIG. 13.

### Training and Evaluation

In FIGS. 15-18, a method, apparatus, and non-transitory computer readable medium for natural language processing are described. One or more embodiments of the method, apparatus, and non-transitory computer readable medium include obtaining a source document; generating, using a language generation model, a topic description based on the source document; computing an objective function that measures a complexity of the topic description; and updating the language generation model based on the objective function.

In some examples, the objective function is based on a percentage of technical words in the topic description or a percentage of technical topic descriptions. Some examples of the method, apparatus, and non-transitory computer readable medium further include generating, using the language generation model, a plurality of topic descriptions based on the source document, wherein the objective function is based on a number of the plurality of topic descriptions.

Some examples of the method, apparatus, and non-transitory computer readable medium further include performing a reinforcement learning process based on the objective function.

Some examples of the method, apparatus, and non-transitory computer readable medium further include obtaining a user characteristic that indicates a complexity preference of a user, wherein the topic description is generated based on the complexity preference.

Some examples of the method, apparatus, and non-transitory computer readable medium further include clustering, using a clustering model, a plurality of sentences of the source document to obtain a plurality of clustered sentences. Some examples further include receiving user feedback based on the plurality of clustered sentences. Some examples further include updating parameters of the clustering model based on the user feedback.

Some examples of the method, apparatus, and non-transitory computer readable medium further include generating a description of an intent of the user feedback. Some examples of the method, apparatus, and non-transitory computer readable medium further include receiving a modified description of the intent of the user feedback. Some examples further include computing a likelihood loss based on the modified description of the intent. Some examples further include updating the parameters of the clustering model based on the likelihood loss.

FIG. 15 shows an example of user feedback 1515 for training a clustering model 1520 according to aspects of the present disclosure. The example shown includes first cluster 1500, second cluster 1505, user 1510, user feedback 1515, clustering model 1520, and description of an intent 1525.

FIG. 15 shows an example of how user feedback 1515 is used in goal-driven clustering to modify initial clusters to obtain a final set of clusters. For example, the initial set of clusters includes first cluster 1500 and second cluster 1505 that are displayed, via an interactive user interface, to user 1510.

In some examples, first cluster 1500 has a title “Introduction to NASH”. Second cluster 1505 has a title “Architecture of NASH”. First cluster 1500 is an example of an initial cluster generated by clustering model 1520. After receiving first cluster 1500 and second cluster 1505, user 1510 can participate in rearranging content among the clusters and the clustering model 1520 generates model explanations based on a user action from user 1510. The user 1510 receives first cluster 1500 and provides user feedback 1515 (e.g., rearranging content from first cluster 1500 to second cluster 1505). The user 1510 rearrange one or more sentences “A neural variational inference framework is proposed for training, where gradients are directly back propagated through the discrete latent variable to optimize the hash function.” from first cluster 1500 to second cluster 1505. Then clustering model 1520 is configured to infer or generate explanation behind this action and display the explanation via a user interface to user 1510. For example, clustering model 1520 presents “You have moved these sentences because all these explain how NASH has been proposed and how the encoder and decoder of the model works along with the mathematical notations, so it doesn't introduce the model, rather explains the architecture in more depth”. Once user 1510 sees the explanation, she/he can either edit the explanation or save the action of rearranging the mentioned sentence(s) from first cluster 1500 to second cluster 1505. The instruction-tuned clustering model 1520 is automatically updated with the goal and the actions based on user feedback 1515.

In some cases, the clustering model 1520 automatically rearranges another sentence “Intuitively, latent codes learned from a model that accounts for the generative term should naturally encapsulate key semantic information from x because the generation/reconstruction objective is a function of p (x|z)” from first cluster 1500 to second cluster 1505 after the user saves.

In some examples, a third cluster has a title “Experimental and Observations”. The clustering model 1520 is trained to learn to rearrange the sentence “Empirically, we found that stochastic binarization shows stronger performance than deterministic binarization, and thus use the former in our experiments” from second cluster 1505 to the third cluster. Clustering model 1520 generates an explanation “the sentence fits observations more than the model architecture of NASH”.

First cluster 1500 is an example of, or includes aspects of, the corresponding element described with reference to FIGS. 13 and 14. Second cluster 1505 is an example of, or includes aspects of, the corresponding element described with reference to FIGS. 13 and 14. User 1510 is an example of, or includes aspects of, the corresponding element described with reference to FIG. 1. Clustering model 1520 is an example of, or includes aspects of, the corresponding element described with reference to FIGS. 6-8.

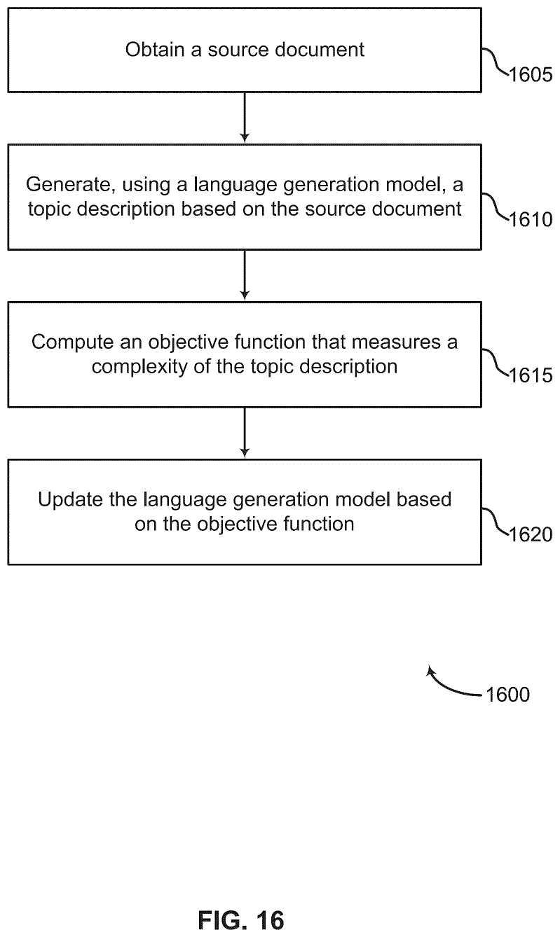

FIG. 16 shows an example of a method 1600 for training a language generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1605, the system obtains a source document. In some cases, the operations of this step refer to, or may be performed by, a language generation model as described with reference to FIGS. 6-8.

In some examples, dataset annotation and creation depend on how users with technical background in machine learning and NLP concepts think of prioritizing content to different audience with prior background knowledge and without prior knowledge. Dataset annotation and creation is also dependent on how well they align their prioritized content depending on the length of the presentation. The training dataset includes scientific documents (pooled from doc2slides dataset). With regards to annotation, a human annotator having enough technical knowledge about the scientific content in the documents that need to be transformed into presentation slides. The annotator is asked to design presentations for each scientific document aligning with the needs of various audience and length, e.g., expert long presentation, expert short presentation, novice long presentation, and novice short presentation.

At operation 1610, the system generates, using a language generation model, a topic description based on the source document. In some cases, the operations of this step refer to, or may be performed by, a language generation model as described with reference to FIGS. 6-8.

At operation 1615, the system computes an objective function that measures a complexity of the topic description. In some cases, the operations of this step refer to, or may be performed by, a training component as described with reference to FIG. 6.

In an embodiment, reinforcement learning method of fine-tuning GPT calls based on user feedback is used to train a language generation model. Using the fine-tuned GPT, the embodiment includes training the policy of the topic generation algorithm to choose a set of topics which have higher number of scientific topics for expert audience (opposite for novice audience) and mostly technical methodology and results heavy for expert audience (opposite for novice audience), similarly based on length of topics for short and long. The RL-based method includes initially conducting Supervised Finetuning of GPT2 (or SFT for short) using topics from an annotated dataset, and more data from the Doc2Slides dataset. In some cases, the language generation model is also referred to as Pre-RL GPT2.

After that, in the reward modeling step, the language generation model is trained to learn a reward function using a neural network to learn the function of mapping topics for both expert and novice short/long presentations with features. The reward function accounts for preference of topics by the target audience and length of output presentation.

At operation 1620, the system updates the language generation model based on the objective function. In some cases, the operations of this step refer to, or may be performed by, a training component as described with reference to FIG. 6.

In an embodiment, the reward function is based on how much technical content is present in the set of topics. For extracting scientific keywords from the text, DistilBERT model fine-tuned on the Inspec Dataset is used to extract scientific keywords from the text. The training component calculates the percentage of scientific keywords in the entire topic text (rₛ). Additionally, the training component uses the topics related to “Experiments”, “Model Architecture”, and “Results and Analysis” sections as technical sections (r_{d}) in an academic paper. For making a presentation for the subject expert audience the percentage of technical keywords and the percentage distribution of these technical sections should be higher compared to the presentation targeted towards the novice audience.

Accordingly, the reward function (Rₜ) is used to optimize generation from GPT comprises (1) Percentage of technical keywords (rₛ); (2) Percentage distribution of technical sections (r_{d}); (3) Length (rₗ).

$${R}_{t} = abs \vert {r}_{s} \vert + abs \vert {r}_{d} \vert + abs \vert {r}_{l} \vert \qquad ( 3 )$$

The reward function (Rₜ) is based on how much technical content is present in the topics. To extract scientific keywords from the source document, an extraction component such as DistilBERT is used. In some examples, DistilBERT is fine-tuned on the Inspec Dataset to extract scientific keywords from the text. The percentage of scientific keywords in the entire topic text is calculated and is denoted by rₛ. The reward function includes ra, rₛ and ry. DistillBERT is a neural network used to generate reward for the generated topics.

In some examples, the topics which are related to ‘Experiments’, ‘Model Architecture’, and ‘Results and Analysis’ sections are used as technical sections (r_{d}) in an academic paper, and for making a presentation for the subject expert audience the percentage of technical keywords and the percentage distribution of these technical sections is higher compared to the presentation targeted towards the novice audience. The number of topics as the length r of the generated topics is computed to account for the length of the presentation.

In some examples, the language generation model uses proximal policy optimization algorithm to further fine-tune topic generation from GPT2 using total reward. This step is referred to as reinforcement learning with human feedback (or RLHF), i.e., optimizes the policy of topic generation considering user preferences.

In some embodiments, updating the language generation model includes performing a reinforcement learning process based on the objective function. Reinforcement learning is one of three basic machine learning paradigms, alongside supervised learning and unsupervised learning. Specifically, reinforcement learning relates to how software agents make decisions to maximize a reward. The decision-making model may be referred to as a policy. This type of learning differs from supervised learning in that labelled training data is not needed, and errors need not be explicitly corrected. Instead, reinforcement learning balances exploration of unknown options and exploitation of existing knowledge. In some cases, the reinforcement learning environment is stated in the form of a Markov decision process (MDP). Furthermore, many reinforcement learning algorithms utilize dynamic programming techniques. However, one difference between reinforcement learning and other dynamic programming methods is that reinforcement learning does not require an exact mathematical model of the MDP. Therefore, reinforcement learning models may be used for large MDPs where exact methods are impractical.

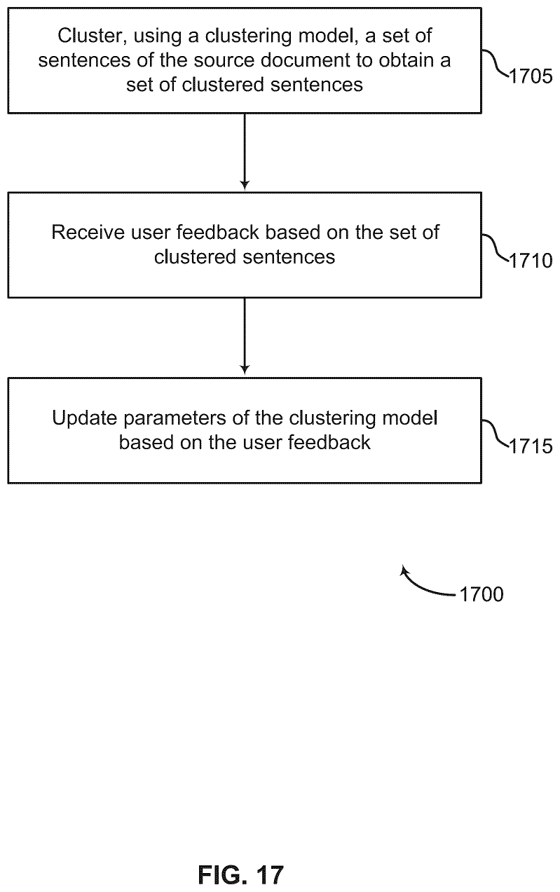

FIG. 17 shows an example of a method 1700 for training a clustering model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1705, the system clusters, using a clustering model, a set of sentences of the source document to obtain a set of clustered sentences. In some cases, the operations of this step refer to, or may be performed by, a clustering model as described with reference to FIGS. 6-8, and 15.

At operation 1710, the system receives user feedback based on the set of clustered sentences. In some cases, the operations of this step refer to, or may be performed by, a clustering model as described with reference to FIGS. 6-8, and 15.

In some cases, users provide one or more goals to describe a topic, such as one user would like to make the evaluation section describe segregating slides based on methods, another might be interested in segregating that with respect to performance on various tasks.

At operation 1715, the system updates parameters of the clustering model based on the user feedback. In some cases, the operations of this step refer to, or may be performed by, a training component as described with reference to FIG. 6.

In an embodiment, a clustering model incorporates an explanation-driven (goal-driven) clustering algorithm to align extracted and retrieved content to customize user needs. The clustering model is configured to provide the rationale behind why the content is placed in a single cluster, a crisp description of such a rationale can be thought of as a slide title/cluster heading. This is initially achieved using zero-shot and few-shot large language model (LLM).

In an embodiment, using human feedback where the users can rearrange sentences, tables, figures from a first slide to a second slide or remove content, the clustering model can be instruction-tuned (e.g., LLAMA2) to customize based on user-specified broader goals. While they save their feedback, the clustering model infers and generates an explanation of why a user has performed an action. The model-generated explanation is shown to the user asking for verification. For example, when content is dragged from the Results section and dropped into the Motivation section by the user, the clustering model generates a plausible explanation behind such action, and the user is asked to provide verification. Once the user verifies, the new clusters are saved with new explanations and user actions with the correct rationale. The clusters and the edited history of user actions are collected through an interface, and accordingly this becomes the new augmented instruction-tuning data for the clustering model (e.g., LLAMA2).

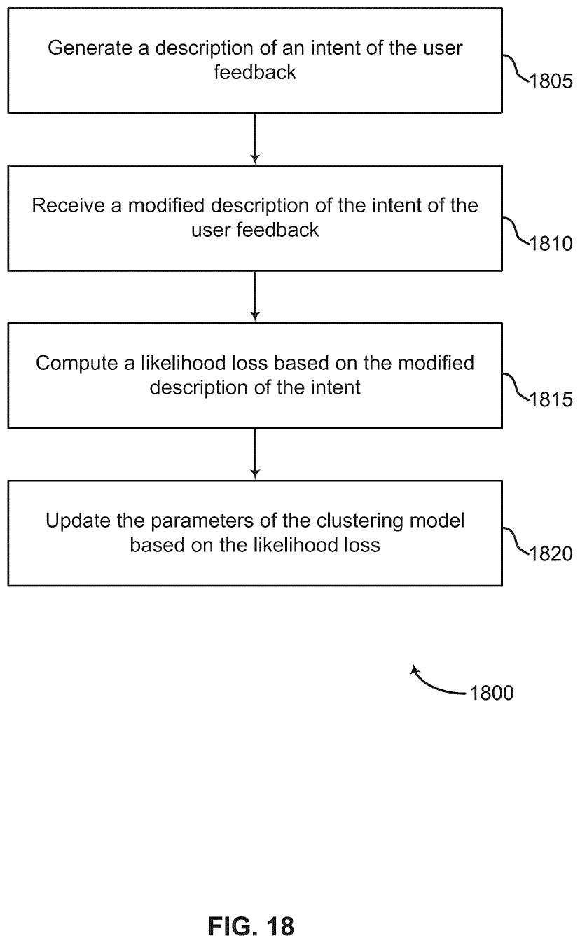

FIG. 18 shows an example of a method 1800 for training a clustering model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1805, the system generates a description of an intent of the user feedback. In some cases, the operations of this step refer to, or may be performed by, a clustering model as described with reference to FIGS. 6-8, and 15.

At operation 1810, the system receives a modified description of the intent of the user feedback. In some cases, the operations of this step refer to, or may be performed by, a clustering model as described with reference to FIGS. 6-8, and 15.

At operation 1815, the system computes a likelihood loss based on the modified description of the intent. In some cases, the operations of this step refer to, or may be performed by, a training component as described with reference to FIG. 6.

In an embodiment, large language models (LLMs) are trained on a massive text corpus using maximum likelihood estimation (MLE) loss:

$${L}_{MLE} ( y ) = - \frac{1}{\vert y \vert} {\sum }_{t} log ( p ( {y}_{t} \vert {y}_{< t} ; θ ) ) \qquad ( 4 )$$

where θ represents the parameters of the base model.

The pre-training objective function compels the model to predict the next token yₜ given its prefix y_{<t}=[y₀, y₁, . . . , yₜ₋₁]. A pre-trained LLM can generate fluent continuations given almost any prefix. However, the generated continuations may not align well with user preferences. It is essential to encourage the generation of content that follows user instructions and aligns with user preferences. The instruction-tuning paradigm includes fine-tuning the base LLMs in a supervised manner on instruction-response pairs {i, r} (where i is an instruction and r is its response) using MLE loss:

$${L}_{MLE} ( i , r ) = - \frac{1}{\vert r \vert} log ( p ( r \vert i ; {θ}^{′} ) ) \qquad ( 5 )$$

where θ′ represents the parameters of the instruction-tuned model.

MLE loss is a type of loss function. MLE can be used for estimating the parameters of a model. The MLE loss, or negative log-likelihood, is the objective function that is minimized during this estimation process. It represents the discrepancy between the observed data and the model under the given parameters. Minimizing this loss results in the parameter estimates that are most likely to have produced the observed data.

The term “loss function” refers to a function that impacts how a machine learning model is trained in a supervised learning model. Specifically, during each training iteration, the output of the model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

At operation 1820, the system updates the parameters of the clustering model based on the likelihood loss. In some cases, the operations of this step refer to, or may be performed by, a training component as described with reference to FIG. 6. After instruction tuning, it is expected that the model distribution p(⋅|i; θ′) would allocate higher probabilities to proper responses like r rather than undesirable continuations.

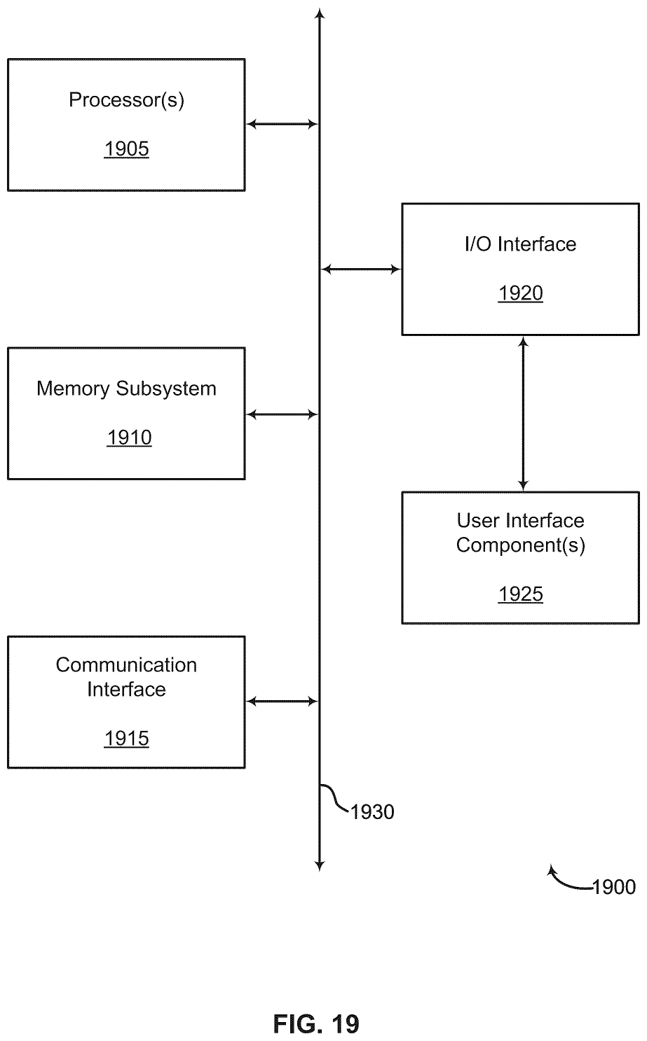

FIG. 19 shows an example of a computing device 1900 for natural language processing according to aspects of the present disclosure. The example shown includes computing device 1900, processor(s) 1905, memory subsystem 1910, communication interface 1915, I/O interface 1920, user interface component(s) 1925, and channel 1930. In one embodiment, computing device 1900 includes processor(s) 1905, memory subsystem 1910, communication interface 1915, I/O interface 1920, user interface component(s) 1925, and channel 1930.

In some embodiments, computing device 1900 is an example of, or includes aspects of, document processing apparatus 110 of FIG. 1. In some embodiments, computing device 1900 includes one or more processors 1905 that can execute instructions stored in memory subsystem 1910 to obtain a source document; obtain a user characteristic that indicates a complexity preference of a user; and generate, using a language generation model, a topic description based on the source document and the user characteristic, wherein the language generation model is trained based on an objective function that measures a complexity of the topic description.

According to some embodiments, computing device 1900 includes one or more processors 1905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some embodiments, memory subsystem 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some embodiments, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna.

According to some embodiments, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or via hardware components controlled by the I/O controller.

According to some embodiments, user interface component(s) 1925 enable a user to interact with computing device 1900. In some cases, user interface component(s) 1925 include an audio device, such as an external speaker system, an external display device such as a display screen, an input device (e.g., a remote control device interfaced with a user interface directly or through the I/O controller), or a combination thereof. In some cases, user interface component(s) 1925 include a GUI.

Performance of apparatus, systems and methods of the present disclosure have been evaluated, and results indicate embodiments of the present disclosure have obtained increased performance over existing technology. Example experiments demonstrate that the document processing apparatus described in embodiments of the present disclosure outperforms conventional systems.

Some examples compare the performance of the RL-finetuned model with model before finetuning. An annotated dataset of personalizedD2S is used (4 parallel set of annotations for each PDF document annotated) for the purpose of evaluation of topic generation. The training policy is based on 80% of the annotated dataset where human annotations are used as feedback to generate topics. Evaluation involves standard metric of generation ROUGE-L or Recall-Oriented Understudy for Gisting Evaluation measures (which compare the predicted generation with a reference annotation; it is based on the Longest Common Subsequence based statistics that considers sentence-level structure similarity naturally and identifies longest co-occurring in sequence n-grams automatically). Example experiments show improvement over the pre-RL GPT2 version due to RL-finetuning.

Some embodiments perform zero-shot GPT4 calls (as opposed to GPT2) with the title and abstract of the paper and specifying the target audience persona and length of the presentation as input in the prompt to generate topic outlines. Some examples experiment with zero-shot GPT4 and few-shot GPT4 (with 5 in-context examples). GPT-4 calls with few-shot in-context examples exhibit competitive performance compared to the zero-shot version.

Some examples involve evaluating whether the personalized retrieval system can extract more customized and personalized content from source documents. The annotated dataset of personalizedD2S (4 parallel set of annotations for each PDF document annotated) for purpose of evaluation of non-personalized content retrieval baseline and the personalized content retrieval system. Accordingly, for each slide topic, evaluation includes comparing the retrieved content and the ground-truth standard content using Rouge-L score. For non-personalized baseline, no constraint is applied to the retriever to choose content based on end user persona or length.

Some example experiments include encouraging results by instruction-tuning LLAMA2 for goal-driven clustering, where collection of user feedback (through rearranging of content, refining of goals) can help generate better collection of instruction tuning data.

The goal-driven clustering model (with reference to FIG. 6) breaks down topic outline (e.g., a list of topics) into multiple clusters depending on their requirements, where each cluster corresponds to one slide. The explanation behind a cluster may be used as the slide title. For example, when a user is shown all the content that is presented under “Introduction and Motivation” topic, the user may hope to see the content in a more fine-grained fashion. The clustering module splits the content into four clusters (four slides) and the fine-grained slides have titles such as “Exposure Bias and Ignoring Output Space Structure”, “Introduction to RNN Language Models and Their Limitations”, “Introduction to Token-level and Sequence-level Loss Smoothing” and “Combining Token-level and Sequence-level Loss Smoothing”.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates the transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Additionally, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

1. A method comprising:
obtaining a source document;
obtaining a user characteristic that indicates a complexity preference of a user; and
generating, using a language generation model, a topic description that conforms to the complexity preference of the user by performing a self-attention mechanism on a sequence of tokens based on the source document and the user characteristic, wherein the language generation model is trained based on an objective function that computes a percentage of technical words in the topic description or a percentage of technical sections.

2. The method of claim 1, wherein:
the complexity preference comprises a topic length preference or an expertise level of the user.

3. The method of claim 1, further comprising:
generating a prompt for the language generation model based on the user characteristic, wherein the topic description is generated based on the prompt.

4. The method of claim 1, further comprising:
generating an output document based on the topic description.

5. The method of claim 4, wherein generating the output document comprises:
generating a prompt that includes instructions to generate the output document.

6. The method of claim 4, wherein generating the output document comprises:
generating a plurality of topics; and
clustering a plurality of sentences from the source document based on the plurality of topics, wherein the output document is based on the clustering.

7. The method of claim 4, further comprising:
obtaining a multi-media asset based on the topic description, wherein the output document includes the multi-media asset.

8. The method of claim 1, further comprising:
displaying the topic description to the user; and
receiving feedback from the user based on the topic description.

9. A method of training a machine learning model, the method comprising:
obtaining a source document;
generating, using a language generation model, a topic description that conforms to a complexity preference of a user by performing a self-attention mechanism on a sequence of tokens based on the source document;
computing an objective function that computes a percentage of technical words in the topic description or a percentage of technical sections; and
updating the language generation model based on the objective function.

10. (canceled)

11. The method of claim 9, further comprising:
generating, using the language generation model, a plurality of topic descriptions based on the source document, wherein the objective function is based on a number of the plurality of topic descriptions.

12. The method of claim 9, wherein updating the language generation model comprises:
performing a reinforcement learning process based on the objective function.

13. The method of claim 9, further comprising:
obtaining a user characteristic that indicates the complexity preference of the user, wherein the topic description is generated based on the complexity preference.

14. The method of claim 9, further comprising:
clustering, using a clustering model, a plurality of sentences of the source document to obtain a plurality of clustered sentences;
receiving user feedback based on the plurality of clustered sentences; and
updating parameters of the clustering model based on the user feedback.

15. The method of claim 14, further comprising:
generating a description of an intent of the user feedback.

16. The method of claim 15, further comprising:
receiving a modified description of the intent of the user feedback;
computing a likelihood loss based on the modified description of the intent; and
updating the parameters of the clustering model based on the likelihood loss.

17. An apparatus comprising:
at least one processor;
at least one memory including instructions executable by the at least one processor;
a language generation model comprising parameters stored in the at least one memory and trained to generate a topic description that conforms to a complexity preference of a user by performing a self-attention mechanism on a sequence of tokens based on a source document and a user characteristic, wherein the language generation model is trained based on an objective function that computes a percentage of technical words in the topic description or a percentage of technical sections; and
a clustering model comprising parameters stored in the at least one memory and trained to cluster a plurality of sentences of the source document to obtain a plurality of clustered sentences corresponding to the topic description.

18. The apparatus of claim 17, further comprising:
an extraction component configured to extract text from the source document.

19. The apparatus of claim 17, further comprising:
a user interface configured to receive feedback on the topic description or the plurality of clustered sentences.

20. The apparatus of claim 17, wherein:
the language generation model and the clustering model each comprises a transformer network.
